(19) United States
(12) Patent Application Publication
(10) Pub. No.: US 2016/0131566 A1
(43) Pub. Date: May 12, 2016

(54) SYSTEM AND METHOD OF MONITORING VISCOSITY OF FLUID IN REAL-TIME

(71) Applicant: Caterpillar Inc., Peoria, IL (US)

(72) Inventor: Xinyu Ge, Peoria, IL (US)

(73) Assignee: Caterpillar Inc., Peoria, IL (US)

(21) Appl. No.: 14/534,344

(22) Filed: Nov. 6, 2014

(51) Int. Cl. G01N 11/00; G01N 29/02; G01K 13/02

(52) U.S. Cl. CPC G01N 11/00; G01K 13/02; G01N 29/02; G01K 2013/026; G01N 2291/022

(57) ABSTRACT

A method of monitoring a quality of a fluid includes maintaining distinct temperatures in at least three different locations along a flow path of the fluid. The method also includes determining viscosity values of the fluid in the at least three different locations along the flow path. The method further includes determining a viscosity-temperature plot based on the viscosity values determined from the at least three different locations and determining a viscosity index of the fluid from the viscosity-temperature plot.

### TECHNICAL FIELD

The present disclosure relates to a method of monitoring a viscosity of a fluid in real-time, and more specifically to a system and method of monitoring a quality of a fluid in real-time.

### BACKGROUND

Typically, fluids such as lubricant oil, hydraulic fluid, turbine oil and the like may be used in various machines or equipment. During operation of the machines or the equipment, various factors may contribute to a change in quality of the fluid and/or the viscosity of the fluid. The quality of the fluids may degrade due to contamination with soot, dust, and the like. Presence of soot may change a viscosity of the lubricating fluid in the engines. Further, a mixing of the fluids with metal particulates may also degrade a quality of the fluid.

Using the machine with the degraded fluid may cause wear, corrosion to one or more parts of the machine. Moreover, an efficiency of the machine may also decrease upon using the degraded fluids. In some cases, degradation in the quality of the fluid may also cause breakdowns of the machines or the equipment. Therefore, continuous monitoring of the quality and/or viscosity of the fluid is essential to prevent these problems from occurring. Various technologies related to such monitoring of the quality/viscosity of the fluid have been proposed.

For reference, U.S. Pat. No. 5,571,950 (hereinafter '950 patent) discloses a method for testing a sample for soot-related viscosity increase. The method includes a step (a) of preparing the sample which comprises a major amount of an oil of lubricating viscosity, a step (b) of measuring the viscosity of the sample and a step (c) of preparing a stable sample/paste dispersion of the sample and a carbon black paste. The method also includes a step (d) of equilibrating the sample/paste dispersion, and a step (e) of measuring the viscosity of the sample/paste dispersion. The '950 patent is also related to a method for predicting physical effects of soot-loading on a sample in a test which measures viscosity increase. The method for predicting the physical effects includes a step (1) of measuring viscosity increase for a series of reference fluids in the test, a step (2) of measuring viscosity increase for the series of reference fluids in a method having steps (a) to (e). The method for predicting the physical effects further includes a step (3) of developing a curve, a step (4) of evaluating the sample using the method having steps (a) to (e), and a step (5) of interpolating a viscometric effect for the sample using the curve.

However, the methods of '950 patent may not provide monitoring of the viscosity and/or quality of the fluid in real-time. The present disclosure is directed to mitigating or eliminating one or more of the drawbacks discussed above.

### SUMMARY OF THE DISCLOSURE

In one aspect of the present disclosure, a method of monitoring a viscosity of a fluid includes maintaining distinct temperatures in at least three different locations along a flow path of the fluid. The method also includes determining viscosity values of the fluid in the at least three different locations along the flow path. The method further includes determining a viscosity-temperature plot based on the viscosity values determined from the at least three different locations and determining a viscosity index of the fluid from the viscosity-temperature plot.

In another aspect of the present disclosure, a system for monitoring a viscosity of a fluid includes a tube configured to provide a laminar flow of the fluid therethrough. The system also includes a plurality of heating elements disposed on an inner surface of the tube. The heating elements are configured to maintain distinct temperatures in at least three different locations along a flow path of the fluid. The system also includes a plurality of viscosity sensors disposed at least in the three different locations along the tube. The viscosity sensors are configured to determine viscosity values of the fluid in each of the at least three different locations. The system also includes a plurality of temperature sensing elements configured to determine a temperature in each of the at least three different locations. The system further includes a controller configured to determine a viscosity-temperature plot based on the viscosity values determined from the at least three different locations, and determine a viscosity index of the fluid from the viscosity-temperature plot.

### BRIEF DESCRIPTION OF THE DRAWINGS

FIG. 1 is a block diagram of a system for monitoring a viscosity of a fluid, according to an embodiment of the present disclosure;

FIG. 2 is a perspective view of a tube of the system of FIG. 1, according to an embodiment of the present disclosure;

FIG. 3 illustrates an exemplary viscosity-temperature plots, according to an embodiment of the present disclosure;

FIG. 4 is a flowchart for calibration mode of the system, according to an embodiment of the present disclosure; and

FIG. 5 is a flowchart for a method of monitoring a quality of a fluid, according to an embodiment of the present disclosure.

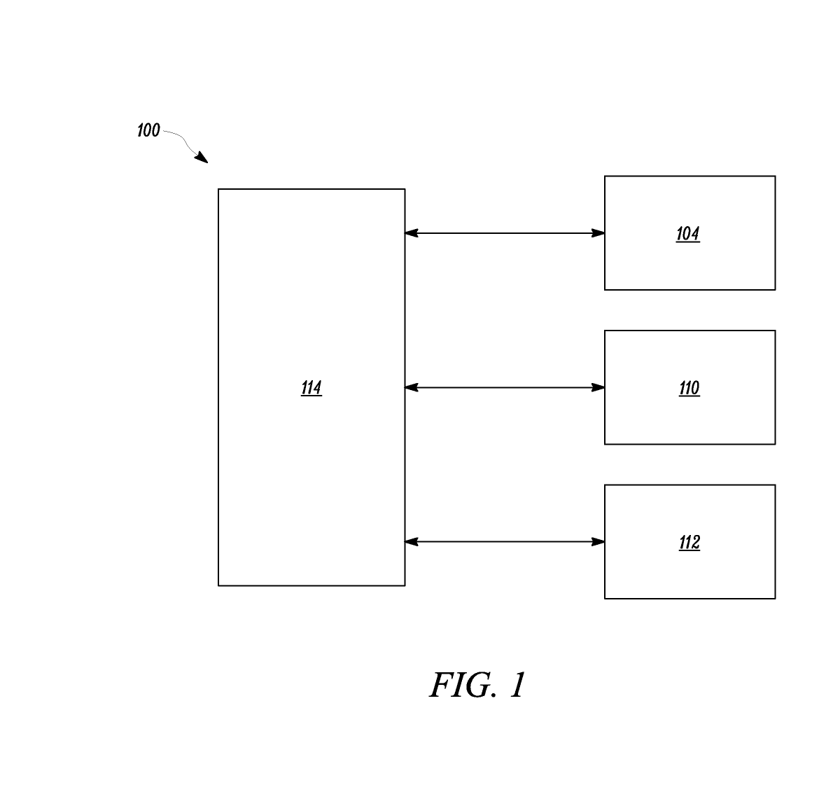

### DETAILED DESCRIPTION

Wherever possible, the same reference numbers will be used throughout the drawings to refer to the same or the like parts. Referring to FIG. 1, a block diagram of an exemplary system 100 configured to monitor viscosity of a fluid is illustrated. The fluid may be engine oil, hydraulic fluid, turbine oil and the like. In an example, the fluid may be used to lubricate one or more movable parts of a machine such as, an engine (not shown). The engine may include a pump configured to supply the fluid from an oil pan to various parts of the engine. In another example, the fluid may act as a medium through which power is transferred in hydraulic machinery.

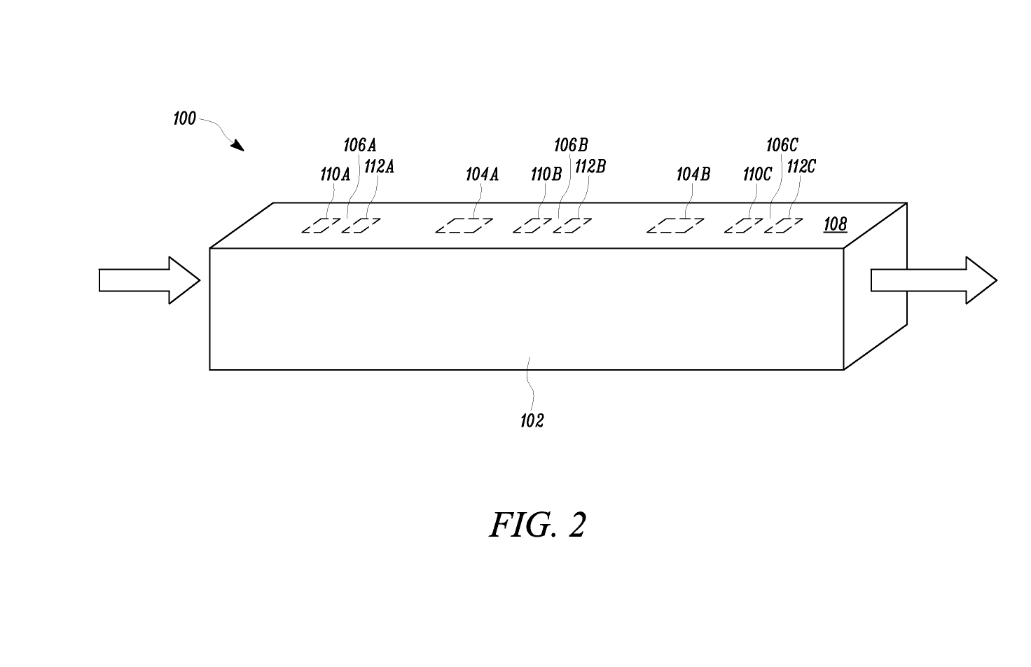

Referring to FIGS. 1 and 2, the system 100 includes a tube 102 configured to provide a laminar flow of the fluid therethrough. Further, the tube 102 may have a suitable hydraulic diameter so as to provide the laminar flow of the fluid. In an example, the tube 102 may be disposed in fluid communication with at least one of the pump and the oil pan of the engine. As such, the tube 102 may receive the fluid from the pump or the oil pan and allow a passage of the fluid therethrough. However, a person of ordinary skill will acknowledge that the tube 102 may be suitably arranged in various other machines or equipment so as to provide the laminar flow of the fluid therethrough.

The system 100 also includes multiple heating elements 104 disposed on an inner surface 108 of the tube 102. The heating elements 104 may be configured to maintain distinct temperatures in different locations 106 along a flow path of the fluid in the tube 102. In the illustrated embodiment, two heating elements 104A, 104B (also collectively referred to as “the heating element/s 104”) are disposed on the inner surface 108 of the tube 102. The heating elements 104A, 104B are configured to maintain distinct temperatures at three different locations 106A, 106B, 106C (also collectively referred to as “the location/s 106”) along the flow path of the fluid respectively. In an example, the heating element 104 may be a heating pad. In another example, the heating element 104 may be a resistive coil.

The system 100 further includes multiple temperature sensing elements 110 and multiple viscosity sensors 112 disposed in the different locations 106 along the flow path. Moreover, the temperature sensing elements 110 and the viscosity sensors 112 are disposed in the inner surface of the tube 102. In the illustrated embodiment, three temperature sensing elements 110A, 110B, 110C are disposed in the locations 106A, 106B, 106C respectively. The temperature sensing elements 110A, 110B, 110C are configured to determine the temperatures in each of the locations 106A, 106B, 106C respectively. In an example, the temperature sensing elements 110 may be thermal couple sensors. However, in various other examples, the heating elements 104 and the temperature sensing elements 110 may embody other devices known in the art.

Similarly, three viscosity sensors 112A, 112B, 112C are disposed in the locations 106A, 106B, 106C in the tube 102 respectively. The viscosity sensors 112A, 112B, 112C are configured to determine viscosity values of the fluid in the locations 106A, 106B, 106C along the flow path respectively. In an example, the viscosity sensors 112 may be acoustic wave sensors such as, but not limited to, thickness shear mode (TSM) resonator, surface acoustic wave (SAW) sensor, acoustic plate mode (APM) sensor, and flexural plate-wave (FPW) sensor. The acoustic wave sensors may be configured to measure wave characteristics of the fluid flow such as, a phase and an amplitude. The viscosity value may be obtained from the wave characteristics measured by the acoustic wave sensors. However, in various other examples, the viscosity sensors 112 may be any other sensor known in the art configured to determine the viscosity values.

Referring to FIG. 1, the system 100 further includes a controller 114. The controller 114 may be connected in electronic and controllable communication with the heating elements 104, the temperature sensing elements 110 and the viscosity sensors 112. The controller 114 may embody a single microprocessor or multiple microprocessors configured for receiving signals from the components of the system 100. Numerous commercially available microprocessors may be configured to perform the functions of the controller 114. It should be appreciated that the controller 114 may embody a machine microprocessor capable of controlling numerous machine functions. A person of ordinary skill in the art will appreciate that the controller 114 may additionally include other components and may also perform other functions not described herein. The controller 114 can also be configured to receive inputs from an operator via a user interface (not shown). In an example, the controller 114 may be an Engine Control Module (ECM) of the engine.

The controller 114 may receive signals indicative of the viscosity values and the corresponding temperatures from the viscosity sensors 112 and the temperature sensing elements 110 respectively. At each instant, the controller 114 may obtain the viscosity values and the temperatures in the locations 106A, 106B, 106C along the flow path of the fluid.

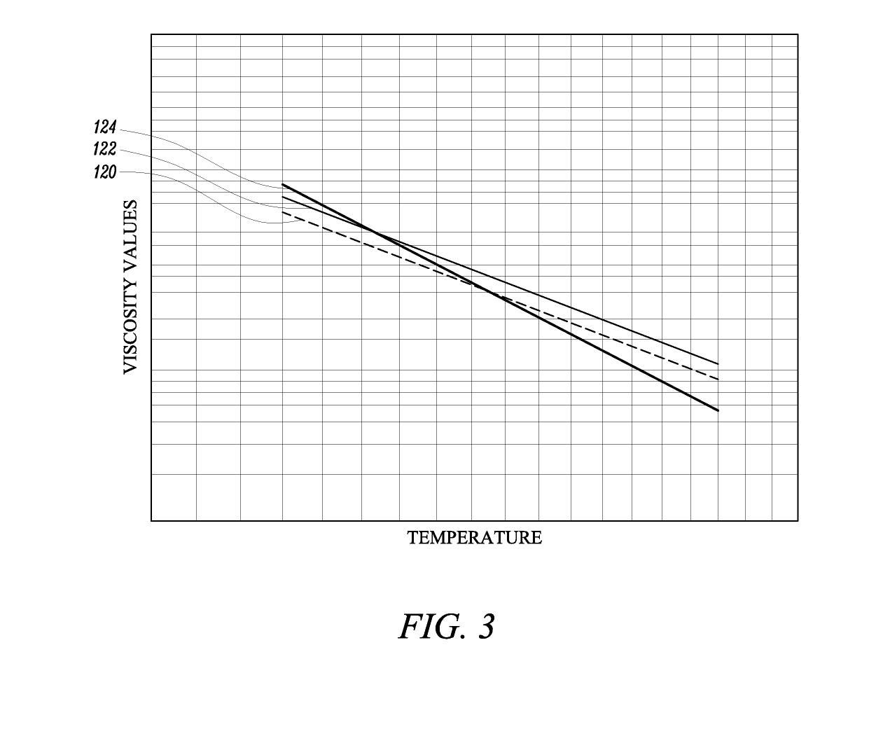

The controller 114 is further configured to determine a viscosity-temperature plot based on the viscosity values. Exemplary viscosity-temperature plots are illustrated in FIG. 3. In an embodiment, the controller 114 may determine the viscosity-temperature plot based on an interpolation of the viscosity values obtained at the temperatures in the locations 106A, 106B, 106C. The interpolation methods may be, regression analysis, curve fitting process or other methods known to one of ordinary skill in the art.

The controller 114 may also be configured to determine a quality of the fluid based on the viscosity-temperature plot. The quality of the fluid may be influenced due to various factors such as, but not limited to, an increase in soot level in the fluid, contamination, presence of metal particulates in the fluid, and the like.

In one embodiment, the controller 114 may determine the quality of the fluid based on a comparison of the viscosity-temperature plot with an expected viscosity-temperature plot. The expected viscosity-temperature plots at various temperature ranges for the fluid may be stored in a memory associated with the controller 114. The controller 114 may identify one or more deviations based on the comparison. The deviations may be, a shift in the viscosity-temperature plot from the expected viscosity-temperature plot and/or a change in a slope of the viscosity-temperature plot from the expected viscosity-temperature plot.

In an exemplary embodiment illustrated in FIG. 3, the viscosity-temperature plots are represented by two viscosity-temperature lines 122, 124 at the temperatures in the locations 106. Further, an exemplary expected viscosity-temperature plot is represented by a viscosity-temperature line 120 in a temperature range indicated by the temperatures in the locations 106. The controller may be configured to determine different qualities of the fluid based on the deviations of the viscosity-temperature lines 122, 124 from the expected viscosity-temperature line 120. According to one example, the controller may determine the quality of the fluid based on a shift in the viscosity temperature line 122 from the expected viscosity-temperature line 120. According to another example, the controller may determine the quality of the fluid based on the change in slope of the viscosity-temperature line 124 from the expected viscosity-temperature line 120.

In another embodiment, the controller 114 may determine the quality of the fluid based on a comparison of the viscosity-temperature plots obtained at pre-defined intervals. The controller 114 may identify the deviations such as, a shift in the viscosity-temperature plots obtained at the pre-defined intervals, a change in slope of the viscosity-temperature plots obtained at the pre-defined intervals. The pre-defined intervals may be input by an operator for storage in the memory.

The controller 114 may determine the quality of the fluid based on the above mentioned comparisons. Further, an amount of deviation may be associated with a decrement value for the quality of the fluid. The controller 114 may determine a low quality for the fluid based on the deviations.

The controller 114 may further generate a flag based on the quality determination. In one example, the controller 114 may generate a flag upon identifying the low quality of the fluid. Specifically, the controller 114 may generate a flag when the quality of the fluid is less than a pre-determined quality. The pre-determined quality for the fluid may be stored in the memory associated with the controller 114. Additionally, the controller 114 may generate an alert for the operator upon determining the low quality for the fluid. The alert may be audible, visible, tactile, or a combination thereof. Further, the controller 114 may also perform additional functions, for example, controlling an engine speed, upon determining the low quality for the fluid. The controller 114 may also store the information related to the fluid such as, the quality of the fluid, viscosity-temperature plots, and the like in the memory.

The controller 114 is further configured to determine a viscosity index of the fluid based on the viscosity-temperature plot. The viscosity index is a measure of a change of a viscosity of the fluid with variations in a temperature. A high viscosity index for the fluid indicates a lesser change in viscosity with temperature. A low viscosity index for the fluid indicates a greater change in viscosity of the fluid with temperature. For example, a decrease in the viscosity index indicates a decrease in a quality of the fluid. As such, the fluid with low viscosity index is indicative of low quality. The controller 114 may be configured to continuously monitor the viscosity index of the fluid and raise a flag when the viscosity index falls below a pre-determined minimum viscosity index.

In an embodiment, the controller 114 is configured to switch to a calibration mode. In the calibration mode, the controller 114 is configured to calibrate the viscosity sensors 112. The controller 114 may switch to the calibration mode in pre-defined time intervals. The pre-defined time intervals may be set by an operator and stored in the memory. The system 100 may monitor the quality of the oil and at the pre-defined time intervals, the controller 114 may switch to the calibration mode. Additionally or optionally, the controller 114 may switch to the calibration mode upon detecting an alert indicating the low quality of the fluid. Alternatively the calibration mode may be initiated by an operator.

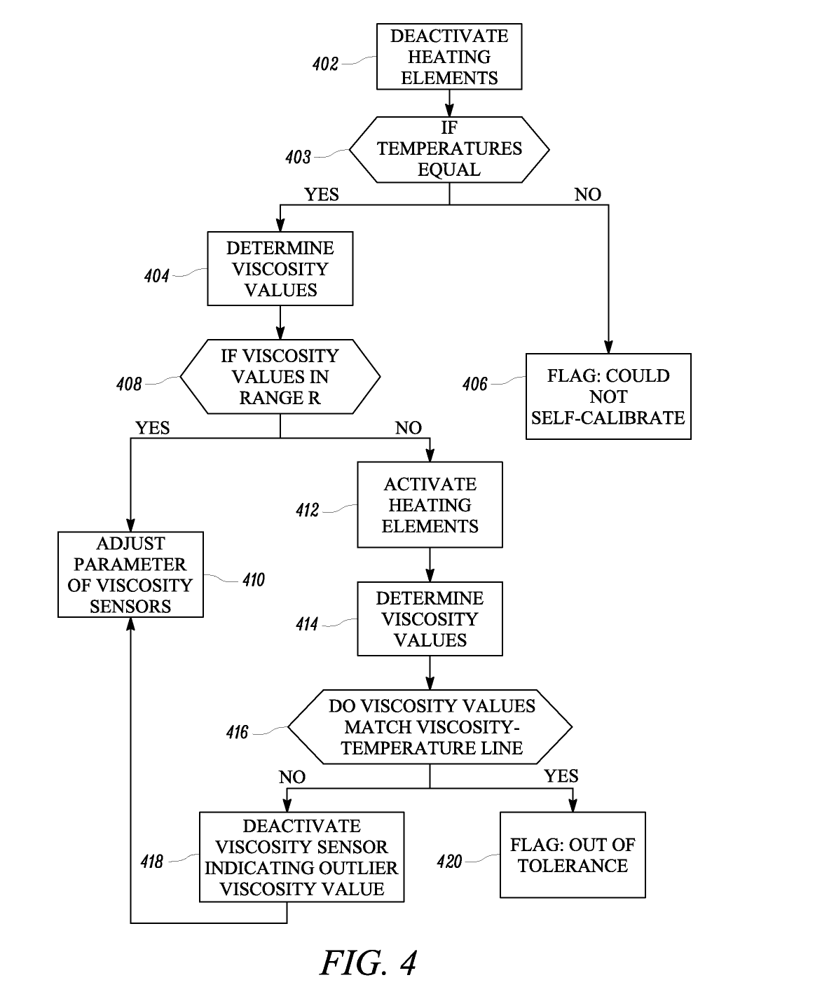

Referring to FIG. 4, a flow chart for the calibration mode is illustrated. In the calibration mode, at step 402, the controller 114 may deactivate the heating elements 104 to maintain substantially same temperatures in each of the locations 106A, 106B, 106C. Moreover, the controller 114 may deactivate the heating elements 104 so as to substantially equalize the temperatures in the locations 106 to a steady state temperature value T0. Further, the temperature sensing elements 110 may determine the steady state temperatures in the locations 106.

At step 403, the controller may check 106 to determine if the temperatures in the locations are substantially equal to the steady state temperature value T0. Moreover, the temperatures in the locations 106 may be checked for predetermined times. In an embodiment, a tolerance may be allowed between each of the steady state temperatures at the step 402. In the calibration mode, the controller 114 is configured to calibrate the viscosity sensors 112. In such a case, the controller 114 may consider the steady state temperatures falling between (T0−0.2 and T0+0.2) at the step 404.

However, if at step 403, the temperatures does not become steady after checking for predetermined times, the controller 114 may generate a flag indicating that the system 100 may not be calibrated at step 406. Moreover, the flag may also indicate that one or more of the temperature sensing elements 110 are faulty.

At step 404, the controller 114 may determine steady state viscosity values from the viscosity sensors 112 in the locations 106 at the steady state temperatures.

At step 408, the controller 114 may further determine if the steady state viscosity values falls within a range R as calculated from a pre-defined statistical method. According to one of the pre-defined statistical methods, the range R may be a function of an average A and a standard deviation D of the steady state viscosity values.
For example, the range R may be (A−m*D A+m*D).
Wherein m is a multiplier such as, 1, 2, 3, . . . N;
A is the average; and
D is the standard deviation.

If at step 408, the controller 114 determines that each of the steady state viscosity values falls within the range R, a control may go to step 410 where the controller 114 may adjust parameters of at least one of the viscosity sensors 112. In one example, the parameters may be offsets directly applied to the viscosity values. In another example, the parameters may be function coefficients that are used to correlate the physical wave characteristics to the viscosity value determined from the acoustic wave viscosity sensor 112. The controller 114 may also adjust parameters associated with the interpolation method that is used to determine the viscosity-temperature plot. In an example, the parameters associated with the interpolation method may be regression coefficients. Moreover, the controller 114 may adjust the parameters to obtain a new steady state viscosity values from the viscosity sensors 112 that are within a pre-determined tolerance range.
For example, the pre-determined tolerance range may be (A−t A+t)
Wherein, A is the average;
t is a desired tolerance; wherein t<m*D.

However, if at step 408, the controller 114 determines that at least one of the steady state viscosity values falls outside the range R, the control may go to step 412 where the controller 114 controller 114 may check for a faulty viscosity sensor among the viscosity sensors 112. At step 412, the controller 114 may activate at least one of the heating elements 104A, 104B so as to obtain distinct temperatures in the locations 106A, 106B, 106C along the flow path. The heating elements 104 may be configured to maintain a test temperature in each of the locations 106A, 106B, 106C. In an example, the test temperatures may be in a linear range. At step 414, the controller 114 may determine test viscosity values from the viscosity sensors 112A, 112B, 112C at these test temperatures in the locations 106A, 106B, 106C.

At step 416, the controller 114 may check for an outlier viscosity value among the test viscosity values in order to identify the faulty viscosity sensor. In the illustrated embodiment, at step 416, the controller may determine if the test viscosity values match an expected viscosity-temperature line. The controller 114 may also determine the expected viscosity-temperature line for the fluid in a temperature range indicated by the test temperatures. In an example, the controller 114 may select and/or retrieve the expected viscosity-temperature line from the memory based on the temperature range indicted by the test temperatures. The controller 114 may determine if any of the test viscosity values are substantially falling out of the expected viscosity-temperature line. The outlier viscosity value may have a deviation from the expected viscosity-temperature line that is greater than a threshold deviation.

At step 418, the controller 114 may generate a flag to the viscosity sensor 112 that corresponds to the outlier viscosity value falling out of the viscosity-temperature line. At step 418, the controller 114 may also deactivate the viscosity sensor 112 that corresponds to the outlier viscosity value.

Additionally, upon generating the flag at step 418, the control may return to step 410, at which the controller 114 may adjust parameters related to the remaining viscosity sensors 112 that are not flagged and/or deactivated. Moreover, the controller 114 may adjust the parameters to obtain the test viscosity values within a desired tolerance range.

For example, at step 416, the controller 114 may check if the test viscosity values obtained from the viscosity sensors 112A, 112B, 112C matches with the expected viscosity-temperature line. If the controller 114 determines that the test viscosity value from the viscosity sensor 112C falls out of the expected viscosity-temperature line, the controller 114 may generate a flag to the viscosity sensor 112C at step 418. Further, the controller 114 may return the control to step 410 at which the parameters related to the remaining viscosity sensors 112A, 112B may be adjusted.

However, if at step 416, all the test viscosity values match with the expected viscosity-temperature line, the controller 114 may generate a flag indicating that the test viscosity values are out of tolerance at step 420. In the calibration mode, the control flows to the step 416 from the step 408, after determining that at least one of the steady state viscosity values determined from the corresponding viscosity sensors 112 at substantially same temperatures falls outside the range R. However, at step 416, the test viscosity values determined at different test temperatures generally matches with the expected viscosity-temperature line and/or no outlier viscosity value may be identified if more than one viscosity sensors 112 are faulty and/or out of tolerance. Therefore, at step, 420, the controller 114 may generate the flag indicating that the test viscosity values are out of tolerance.

Moreover, for monitoring the viscosity of the fluid, the controller 114 may check for any flags or alerts generated during the calibration mode. The controller 114 may process only the viscosity values from the viscosity sensors 112 without a flag for monitoring of the viscosity.

The system 100, as described above, is exemplary in nature, and variations are possible within the scope of the present disclosure. For example, the system 100 may include more than three viscosity sensors 112 and correspondingly more than three temperature sensing elements 110. Correspondingly, the controller 114 may be configured to determine the viscosity-temperature plot based on more than three viscosity values determined in the corresponding locations 106 along the flow path of the fluid.

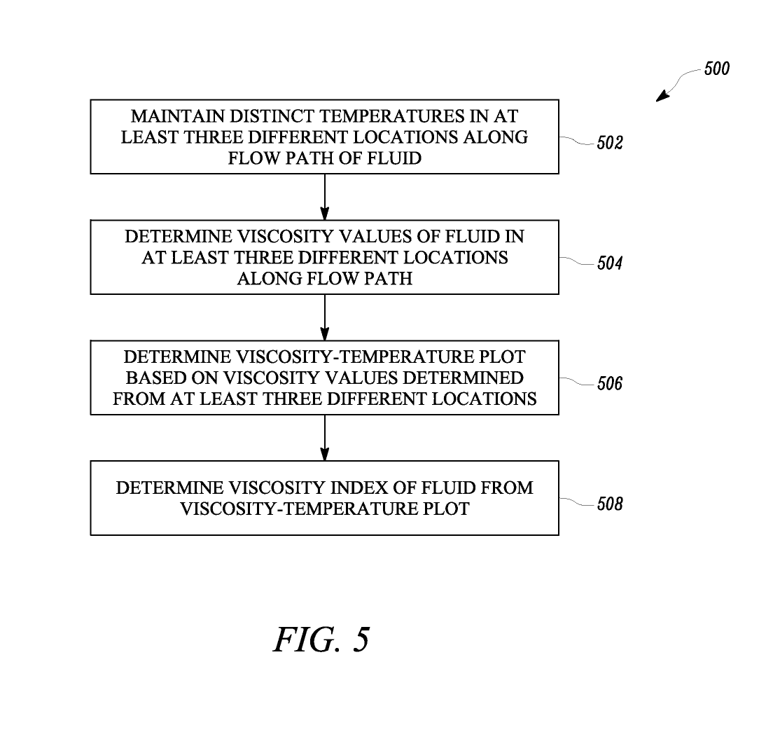

FIG. 5 illustrates a flowchart for a method 500 of monitoring a viscosity of the fluid. In an embodiment, the system 100 may be employed to implement one or more steps of the method 500. At step 502, the method 500 includes maintaining distinct temperatures in at least three different locations 106 along the flow path of the fluid. In the illustrated embodiment, the heating elements 104A, 104B, 104C disposed on the inner surface 108 are configured to maintain distinct temperatures in the locations 106A, 104B, 104C along the flow path. At step 502, the method 500 may also includes determining temperatures in the at least three different locations 106. The temperatures in the locations 106A, 106B, 106C may be determined via the temperature sensing elements 110A, 110B, 110C disposed in the locations 106.

At step 504, the method 500 includes determining viscosity values of the fluid in the at least three different locations 106 along the fluid path. In the illustrated embodiment, the viscosity values in the locations 106A, 106B, 106C may be determined from the viscosity sensors 112A, 112B, 112C disposed along the flow path of the tube 102. The temperatures and the corresponding viscosity values may be communicated to the controller 114.

At step 506, the method 500 includes determining the viscosity-temperature plot based on the viscosity values determined from the at least three different locations 106. In the illustrated embodiment, the viscosity-temperature plot may be determined by interpolating the viscosity values determined from the viscosity sensors 112. An exemplary viscosity-temperature plot is illustrated in FIG. 3.

At step 508, the method 500 includes determining the viscosity index of the fluid from the viscosity-temperature plot. The method 500 may further include determining the quality of the fluid based on the viscosity temperature plot. In one embodiment, the quality of the fluid may be determined based on a comparison of the viscosity-temperature plot with the expected viscosity-temperature plot. Moreover, the comparison is to identify the deviations such as, a shift in a shift in the viscosity-temperature plot from the expected viscosity-temperature plot, a change in a slope of the viscosity-temperature plot from that of the expected viscosity-temperature plot.

In another embodiment, the quality of the fluid may be determined based on a comparison of the viscosity-temperature plots obtained at the pre-defined intervals. Moreover, the comparison is to identify the deviations such as, a shift in the viscosity-temperature plots obtained at the pre-defined intervals, a change in slope of the viscosity-temperature plots obtained at the pre-defined intervals.

In yet another embodiment, a quality of the fluid may be determined based on the viscosity index. A higher viscosity index indicates a higher quality for the fluid. Similarly, a lower viscosity index indicates a lower quality for the fluid. Therefore, the viscosity index for the fluid may be compared to the pre-determined minimum viscosity index. The method 500 may further include generating a flag indicating low quality of the fluid, if the viscosity index of the fluid is less than the pre-determined minimum viscosity index.

The method 500 may further include generating a flag based on the quality determination. Additionally, an alert may be generated for the operator upon determining a low quality for the fluid. The alert may be audible, visible, tactile, or a combination thereof. In an embodiment, other additional functions such as, controlling engine speed and the like may be performed upon determining the low quality for the fluid.

In an embodiment, the method 500 may also include switching to the calibration mode as explained above with reference to FIG. 4. In the calibration mode, the viscosity sensors 112 may be self-calibrated by implementation of one or more of the steps 402, 403, 404, 406, 408, 410, 412, 414, 416, 418, 420. As such, in the calibration mode, a faulty viscosity sensor 112 may be identified and correspondingly, a flag and/or an alert may be generated. Further, the parameters related to the viscosity sensors 112 may be adjusted so as to obtain the viscosity values in the pre-determined tolerance range.

Although, the method is explained in conjunction with determining the viscosity-temperature plot from three viscosity values determined at the three locations 106, a person of ordinary skill in the art will appreciate that the viscosity-temperature plot may be determined from any number of viscosity values may be determined at different temperatures.

### INDUSTRIAL APPLICABILITY

Machines, such as, internal combustion engines, hydraulic machines, and the like may use fluids for various purposes such as, lubrication, braking, transmitting power and the like. During operation, a quality of the fluids may deteriorate due to presence of soot, dust, or other foreign particles. Moreover, the quality may change when the fluid due to a presence of metal particulates in the fluid. Such reduction in quality of the fluid may cause wear and corrosion to one or more components of the machine. Moreover, a low quality fluid may also reduce an efficiency of the machine. In such a case, an operator may need to change the fluid.

Viscosity of the fluid depends on a temperature. A viscosity reading may also be impacted by flow characteristics of the fluid. For example, the laminar flow or turbulent flow characteristics may impact measurement of the viscosity values. Therefore, the flow may need to be maintained consistently through out the monitoring process to obtain consistent readings. With use of the system 100 and the method 500 of the present disclosure, a laminar flow of the fluid though the tube 102 is provided thereby enabling an accurate and consistent monitoring of the viscosity and/or quality of the oil.

Further, with an implementation of the method 500 and the system 100, a viscosity of the fluid may be monitored in real-time. The viscosity-temperature plots and the viscosity index of the fluid may be determined continuously. Moreover, the quality of the fluid may be determined based on at least one of the viscosity-temperature plot and the viscosity index. As such, the quality of the fluid may also be determined in real-time. Moreover, upon determining a low quality for the fluid, a flag and/or alert may be generated for an operator for undertaking necessary actions.

The system 100 includes multiple viscosity sensors 112 that may be calibrated from time to time. Due to prolonged operation of the system 100 and/or the machine, operating conditions within the machine and the like, one or more viscosity sensors 112 may be faulty. However, with use of the system 100, and/or the method 100, the viscosity sensors 112 may be self-calibrated. Moreover, the viscosity sensors 112 may be self-calibrated during operation of the machine or the equipment thereby minimizing machine downtime and/or external intervention. In the calibration mode, the parameters related to the viscosity sensors 112 may be adjusted to obtain the viscosity values within the pre-determined tolerance range. Further, the calibration mode may also enable identifying of the faulty viscosity sensors which may be subsequently deactivated. Therefore, the monitoring of the viscosity of the fluid may be performed after confirmation of a health of the sensor thereby making the monitoring method 500 more accurate.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of monitoring a viscosity of a fluid, the method comprising:
maintaining distinct temperatures in at least three different locations along a flow path of the fluid;
determining viscosity values of the fluid in the at least three different locations along the flow path;
determining a viscosity-temperature plot based on the viscosity values determined from the at least three different locations; and
determining a viscosity index of the fluid from the viscosity-temperature plot.

2. The method of claim 1 further comprising determining temperatures in the at least three different locations.

3. The method of claim 2, wherein the viscosity-temperature plot is determined based on an interpolation of the viscosity values obtained at different temperatures in the at least three different locations.

4. The method of claim 1 further comprising determining a quality of the fluid based on the viscosity index of the fluid.

5. The method of claim 1 further comprising determining a quality of the fluid based on the viscosity-temperature plot.

6. The method of claim 4, wherein the quality of the fluid is determined based on a comparison of the viscosity-temperature plot with an expected viscosity-temperature plot.

7. The method of claim 6, wherein the comparison is to identify at least one of:
a shift in the viscosity-temperature plot from the expected viscosity-temperature plot; and
a change in a slope of the viscosity-temperature plot from that of the expected viscosity-temperature plot.

8. The method of claim 5, wherein the quality of the fluid is determined based on a comparison of the viscosity-temperature plots obtained at pre-defined time intervals.

9. The method of claim 8, wherein the comparison is to identify at least one of:
a shift in the viscosity-temperature plots obtained at the pre-defined intervals; and
a change in a slope of the viscosity-temperature plots obtained at the pre-defined intervals.

10. The method of claim 5 further comprising generating a flag based on the quality determination.

11. The method of claim 1 further comprising switching to a calibration mode configured to calibrate viscosity sensors disposed at each of the at least three different locations.

12. The method of claim 11, wherein the switching to the calibration mode occurs in pre-defined time intervals.

13. The method of claim 11, wherein the calibration modes comprises:
maintaining a substantially same temperature in each of the at least three different locations along the flow path;
determining viscosity values of the fluid from each of the viscosity sensors disposed at each of the at least three different locations;
determining if the viscosity values from each of the viscosity sensors falls within a range as calculated from a pre-defined statistical method; and
adjusting a parameter of at least one of the viscosity sensors to obtain the viscosity values from each of the viscosity sensors within a pre-determined tolerance range.

14. The method of claim 13 further comprising:
maintaining distinct temperatures in each of the at least three different locations along the flow path, if the viscosity value from any of the viscosity sensors falls outside the range as calculated from the pre-defined statistical method;
determining viscosity values from each of the viscosity sensors disposed at each of the at least three different locations;
determining an expected viscosity-temperature line for the fluid at the distinct temperatures in the at least three different locations;
determining if any one of the viscosity value is substantially falling out of the expected viscosity-temperature line; and
deactivating the viscosity sensor corresponding to the viscosity value substantially falling out of the expected viscosity-temperature line.

15. A system for monitoring a viscosity of a fluid, the system comprising:
a tube configured to provide a laminar flow of the fluid therethrough;
a plurality of heating elements disposed on an inner surface of the tube, wherein the plurality of heating elements are configured to maintain distinct temperatures in at least three different locations along a flow path of the fluid;
a plurality of viscosity sensors disposed at least in the three different locations along the tube, wherein the plurality of viscosity sensors are configured to determine viscosity values of the fluid in each of the at least three different locations;
a plurality of temperature sensing elements configured to determine a temperature in each of the at least three different locations; and
a controller configured to:
determine a viscosity-temperature plot based on the viscosity values determined in the at least three different locations; and
determine a viscosity index of the fluid from the viscosity-temperature plot.

16. The system of claim 15, wherein the viscosity sensors are acoustic wave sensors.

17. The system of claim 15, wherein the viscosity-temperature plot is determined based on an interpolation of the viscosity values obtained at different temperatures in the at least three different locations.

18. The system of claim 15, wherein the controller is further configured to determine a quality of the fluid based on at least one of the viscosity index and the viscosity-temperature plot.

19. The system of claim 18, wherein the quality of the fluid is determined based on a comparison of the viscosity-temperature plot with an expected viscosity-temperature plot.

20. The system of claim 15, wherein the controller is further configured to switch to a calibration mode configured to calibrate the viscosity sensors disposed at each of the at least three different locations.
